(19) United States
(12) Patent Application Publication
(10) Pub. No.: US 2025/0162854 A1
(43) Pub. Date: May 22, 2025

(54) Exchangeable applicator for inserting a flexible line and a dispensing valve in a beverage tapping head

(71) Applicant: Carlsberg Breweries A/S, Copenhagen V (DK)

(72) Inventor: Klaus Laybourn, Copenhagen V (DK)

(73) Assignee: Carlsberg Breweries A/S, Copenhagen V (DK)

(21) Appl. No.: 18/839,490

(22) PCT Filed: Feb. 24, 2023
(86) PCT No.: PCT/EP2023/054640

§ 371 Date: Aug. 19, 2024

(30) Foreign Application Priority Data
Feb. 25, 2022 (EP) 22158838.7

(51) Int. Cl. B67D 1/14; B67D 1/04; B67D 1/08

(52) U.S. Cl. CPC B67D 1/1405; B67D 1/0462; B67D 1/0829; B67D 1/0857; B67D 2210/00049

(57) ABSTRACT

A beverage font assembly includes a tapping head with a valve cavity and a first recess extending from its rear side to the valve cavity. An applicator is sized and shaped to be slidably received in the first recess for placing an exchangeable valve in the valve cavity for controlling the flow of beverage from a dispensing line though the tapping head. The tapping head is movable between an operative position and a service position, its rear side being obscured in the operative position and exposed in the service position.

### TECHNICAL FIELD

The disclosure relates to a beverage dispensing system for dispensing a beverage stored in a beverage container, and more particularly to a beverage font assembly having a tapping head with an exchangeable valve and a corresponding applicator.

### BACKGROUND

Conventional beverage dispensing systems intended for professional or private use such as the DraughtMaster system produced by the applicant company are described in e.g., WO 2007/019848, WO 2007/019849, WO 2007/019850, WO 2007/019851 and WO 2007/019853.

Beverage dispensing systems are typically used in beverage dispensing establishments for efficiently dispensing large quantities of beverage, including carbonated alcoholic beverages such as draught beer and cider, non-alcoholic beverages such as soft drinks and non-carbonated beverages such as wine and fruit juice. Beverage dispensing systems are mostly used by professional users in establishments like bars, restaurants and hotels, however, increasingly by private users in private homes.

In the present context, keg and container are considered to be synonymous words. Beverage dispensing systems for providing draught beverages from exchangeable beverage containers are well known in the art. One example from the prior art is U.S. Pat. No. 3,889,487 disclosing a system in which a beverage keg is connected by a flexible conduit to a faucet on a faucet standard. The keg is kept in a refrigerated chamber and the beverage is pressurized by supplying carbon dioxide into the keg. The beverage is dispensed from the faucet. When the beverage keg is empty, it is removed and returned to the beverage producer. Since most beverages include nutrients and other substances which may promote bacterial growth it is important to clean and sterilize such kegs before re-filling them with beverage. Insufficient cleaning may lead to unhygienic beverage kegs, which may in turn lead to bacterial growth causing health problems for the beverage consumer.

For the same hygienic reasons all parts contacting the beverage must be handled in a sterile way to avoid dirt and bacteria to enter the beverage. Therefore, in most modern beverage dispensing systems the beverage container, the dispensing line connected thereto, and the tapping valve are for single use only. In this way the beverage will be kept away from any possible contaminants during storage and dispensing. To ensure that the sterility of the parts contacting the beverage is maintained, it is generally not recommended to disassemble the parts contacting the beverage, i.e. disconnecting the dispensing line from the container or the tapping valve from the tapping line, since such disconnections would normally compromise the sterile environment of the beverage.

Some beverage dispensing systems, such as the above mentioned DraughtMaster™ system, use a lightweight, collapsible and disposable beverage container or keg for accommodating the beverage and a pressurizing system for allowing the beverage flow from the container to the tapping system. The collapsible beverage container is typically made of thin and flexible plastic material and may even be in the form of a plastic bag. Such beverage dispensing systems using collapsible beverage kegs can have the beverage keg installed or placed in a pressure chamber. Thus, while there is a need to pressurize conventional steel kegs with CO₂, for instance by means of a CO₂-cartridge connected to the keg during dispensing, single-use beverage systems such as the applicant's DraughtMaster uses air from a pressure source, e.g. an air compressor, to push the beer out and collapsing the keg, which means that the beer is not exposed to any source of contamination from when it leaves the brewery until it exits the tapping head through a spout.

While performing a dispensing operation, the pressure applied causes the beverage to flow out of the beverage keg and into a dispensing line. The dispensing line leads to a tapping head comprising a tap handle. The tap handle allows the operator to control the tapping valve and thereby the beverage dispensing operation. Typically, the tap handle is a part of a beverage font mounted in a bar, or when using a smaller beverage dispensing system, such as e.g., the DraughtMaster™, the tap handle is typically mounted on a housing of the beverage dispensing system, and typically in front of the keg, so that the tap handle may be easily used by the operator to dispense the beverage.

After a certain amount of time a layer of residual beverage may be formed inside the dispensing line and tapping head, in particular in the tapping valve and the spout. While the spout is usually easier to clean as it is protruding from the tapping head, layers of residual beverage may solidify and eventually clog the dispensing line and/or the tapping valve that are more difficult to access and clean as they are located inside the tapping head and the font assembly. This buildup of residue can eventually e impair the beverage dispensing operation. However, even before clogging the dispensing line and/or tapping valve, the residual beverage could pose a hygienic problem, since the dispensing line and the tapping valve constitute areas where bacterial growth may be accelerated due to the presence of beverage, the large surface area in comparison to the beverage volume, the lack of sufficient cooling and the close proximity to the environment.

The above problems have been solved in the prior art e.g. by frequent cleaning of the dispensing line and tapping device. Methods and systems for cleaning and flushing the dispensing line are disclosed in the applicant's international applications WO 2010/060949, WO 2010/060946 and WO 2010/029122. In these applications, a cleaning fluid is caused to enter the dispensing line and be dispensed at the dispensing device. The cleaning fluid removes any residual beverage or contamination remaining in the tapping line or tapping cock. Subsequently, the dispensing line is flushed by water to remove the remaining cleaning fluid.

Some other examples of prior art solutions for reducing unhygienic conditions in beverage dispensing systems are discussed below.

In WO 2009/024147, a module for a modular beverage distribution system is disclosed, wherein the system has a separate rinsing line. By using a specially designed discharge valve, alternatively rinsing fluid or beverage may enter the tapping line. Rinsing fluid is provided from a separate pressurized reservoir. The discharge valve includes safety features for avoiding mixing rinsing fluid and beverage.

In WO 2010/029122, a method of cleaning the tapping line of a beverage dispensing system is disclosed in which a cleaning and flushing cartridge for internal use is described. The cleaning and flushing cartridge is installed in the pressure chamber similar to a beverage container and dispensed similar to a beverage.

WO 2010/060946 and WO 2011/117192 both relate to a method of cleaning the tapping line of a beverage dispensing system in which a cleaning and flushing cartridge for external use is described. The cleaning and flushing cartridge is installed outside the pressure chamber and has a pressure fluid source connected. The rinsing and flushing fluid is dispensed similar to a beverage.

EP 1 216 953 relates to a tapping head for drawing beverages under gas pressure. The tapping head has a channel for feeding a disinfecting agent to the area of the beverage closing valve for disinfecting the fitting area.

U.S. Pat. No. 7 237 566 relates to a device for cleaning and/or disinfecting a keg coupler. An adapter can be fitted onto the keg coupler, which adapter comprises can apply a cleaning liquid onto the keg coupler.

One drawback of the above solutions is the fact that a cleaning agent must be provided separately. However, the user may forget to provide this cleaning agent or the use of cleaning agent may even be omitted deliberately for economical and time saving reasons.

Another drawback of these existing systems is that the connection between the dispensing line and the beverage container is usually still not cleaned and thus constitutes a location in which microorganisms (microbes) and similar contamination may enter the beverage container and/or the dispensing line. This connection between the dispensing line and the container is typically established each time a new container is installed by connecting a dispensing line connector to a container connector. The container connector is then exchanged together with the beverage container and may thus be considered to be essentially sterile, at least when being protected by a suitable lid, whereas the dispensing line connector is exchanged significantly less frequently, if ever. The same is true for the dispensing line itself, which is usually embedded into the beverage font or a body of the beverage dispensing system and therefore not replaced together with the beverage container.

This means that microorganisms and contamination may still accumulate on and within the dispensing line and its connector and, when the beverage container is exchanged, such microorganisms may contaminate the previously sterile beverage.

There is thus a need for technologies for preventing bacterial growth at the dispensing line, the dispensing line connector, as well as the tapping head of beverage dispensing systems with exchangeable beverage containers.

### SUMMARY

It is therefore an object of the present disclosure to provide an improved beverage dispensing system that ensures sterile conditions for all parts of the system, especially the valve, the dispensing line, and connecting elements between the dispensing line and the beverage container.

The foregoing and other objects are achieved by the features of the independent claims. Further implementation forms are apparent from the dependent claims, the description and the figures.

According to a first aspect, there is provided a beverage font assembly for dispensing a beverage, the beverage font assembly comprising a tapping head that can be supported by a beverage font or be supportable by a body of a beverage dispensing system. The tapping head defines a valve cavity for receiving an exchangeable valve and optionally also a portion of an exchangeable dispensing line. The exchangeable valve is configured for controlling the flow of beverage through the tapping head. The tapping head comprises a first recess extending from the valve cavity to a side of the tapping head and opening towards the side of the tapping head, and an applicator for placing the exchangeable valve and optionally a portion of the exchangeable dispensing line in the valve cavity by inserting the applicator into the first recess, wherein the applicator is sized and shaped to be slidably received in the first recess, and the applicator is configured for having at least the exchangeable valve releasably attached thereto prior to insertion of the applicator into the first recess.

The beverage font assembly according to this aspect allows easy and effective removal of both the valve and the dispensing line from the tapping head using an applicator specifically adapted to insert and remove the valve and the dispensing line through an opening in a side of the tapping head. This allows cleaning of the valve and the dispensing line without the need for additional cleaning means provided in the beverage dispensing system itself, as well as easy replacement of both the valve and the dispensing line, e.g. together with the beverage container used in the beverage dispensing system, thereby reducing the risk of bacterial growth or clogging in these parts of the beverage dispensing system.

In a possible implementation form of the first aspect the tapping head is movable between an operative position and a service position, the side of the tapping head where the first recess extends and opens to being obscured in the operative position and exposed in the service position. This allows for a space-efficient design while also providing protection for the applicator and the dispending line from possible damages during use of the tapping head.

In a possible implementation form of the first aspect the valve cavity is configured for receiving a portion of an exchangeable dispensing line, wherein the exchangeable valve is configured for controlling the flow of beverage from the exchangeable dispensing line through the tapping head, and the applicator is configured for placing the portion of the exchangeable dispensing line in the valve cavity.

In a possible implementation form of the first aspect the tapping head comprises a front side facing away from the beverage font or body, and an opposing rear side, and the first recess extends from the valve cavity to the rear side of the tapping head and opens towards at least the rear side of the tapping head.

In a possible implementation form of the first aspect the tapping head is provided with at least one tap handle configured to be operatively connected to the exchangeable valve for controlling of the opening and closing thereof when the exchangeable valve is received in the valve cavity. In a possible implementation form of the first aspect the valve cavity is arranged at a first lateral distance from the rear side, and the tap handle is arranged at a second lateral distance from the rear side of the tapping head. This solution allows the valve to be off-axis from the tap handle thereby enabling also that the spout and hence the final outlet opening for the beverage can be arranged closer or further away from the beverage font or body of the beverage dispensing system.

In a possible implementation form of the first aspect the exchangeable valve comprises a valve body and a spout connected to the valve body, the spout preferably being an integral part of the valve body.

In a possible implementation form of the first aspect the applicator defines a second recess shaped and sized to receive and releasably engage the exchangeable valve and to receive a first portion of the exchangeable dispensing line.

In a possible implementation form of the first aspect the second recess comprises a dispensing line section adapted to receive and/or retain the first portion of the exchangeable dispensing line.

In a possible implementation form of the first aspect the second recess comprises a valve section, the valve section being adapted to receive and/or positively retain the valve body, the valve section preferably having an elongated shape.

In a possible implementation form of the first aspect at least an elongated part of the dispensing line section is arranged at an angle, preferably an angle between 45 and 110°, in relation to a longitudinal axis of the valve section, the valve section preferably opening to a side of the applicator that faces downward when the applicator is inserted in the tapping head, at least when the tapping head is in the operative position.

In a possible implementation form of the first aspect the dispensing line section is arranged to receive a first portion of the exchangeable dispensing line comprising a first bend, preferably a 45 to 110° bend, more preferably a substantially 90° bend.

In a possible implementation form of the first aspect the applicator is accessible and removable from a rear side or a top side of the tapping head, for replacing at least one of the exchangeable valve and the portion of an exchangeable dispensing line, from the valve cavity and second recess.

In a possible implementation form of the first aspect the applicator comprises a rear applicator end located at the rear side of the tapping head when the applicator is inserted into the first recess, and a guide channel arranged at the rear applicator end and being adapted to receive and/or retain a second portion of the exchangeable dispensing line.

In a possible implementation form of the first aspect the guide channel is configured to receive a second portion of the exchangeable dispensing line comprising a second bend, preferably a 45 to 110° bend, more preferably a substantially 90° bend, and to align an end of the second portion with the rear side of the tapping head when the applicator is fully inserted into the first recess.

In a possible implementation form of the first aspect the applicator comprises a rear applicator end located at the rear side of the tapping head when the applicator is fully inserted into the first recess, the rear applicator end at least partially protruding from the rear side of the tapping head when the applicator is fully inserted into the first recess to provide a grasping portion for removing the applicator from the first recess.

In a possible implementation form of the first aspect the beverage font assembly comprises a first snap fit arrangement for releasably securing the exchangeable valve to the applicator.

In a possible implementation form of the first aspect the beverage font assembly comprises a second snap fit arrangement for releasably securing a spout to the applicator or to the tapping head.

In a possible implementation form of the first aspect the beverage font assembly comprises a third snap fit arrangement for releasably securing the applicator in the first recess.

In a possible implementation form of the first aspect the first recess is shaped to allow both translational and rotational movement of the applicator therein.

In a possible implementation form of the first aspect the applicator comprises an end stop adapted to limit translational and/or rotational movement of the applicator in the first recess.

In a possible implementation form of the first aspect the beverage font assembly comprises a beverage font, the beverage font being provided with a third recess for receiving a third portion of the exchangeable dispensing line, the third recess preferably extending from the first recess in the tapping head to a base of the beverage font.

In a possible implementation form of the first aspect the valve cavity is arranged to house an actuator mechanism, the actuator mechanism configured to be operably connected to the tap handle and to the exchangeable valve when the exchangeable valve is received in the valve cavity, wherein the actuator mechanism is configured to translate movement of the tap handle between a non-dispensing position and a dispensing position into a movement for changing the valve between closed and open configuration.

According to a second aspect, there is provided a beverage dispensing system comprising a beverage font assembly for dispensing a beverage from an exchangeable keg, the beverage font assembly comprising a tapping head configured for receiving an exchangeable valve; a receptacle for receiving at least part of the exchangeable keg; and a keg closure cavity designed to accommodate the closure of the exchangeable keg, wherein the keg closure cavity is provided with a coupler with a through-hole for allowing passage of the exchangeable dispensing line, wherein the through-hole is configured to receive the keg connection end of the exchangeable dispensing line in a sealing manner and align the keg connection end with the beverage outlet of the exchangeable keg.

The beverage dispensing system is thus configured for receiving an exchangeable keg comprising a closure with a beverage outlet, as well as an exchangeable dispensing line having a dispensing end and a keg connection end for connecting to the beverage outlet, and an exchangeable valve being connected or connectable to the dispensing end of the dispensing line.

The beverage dispensing system according to this aspect allows easy and effective removal of the whole dispensing line together with the valve, and the keg connection end together with the exchangeable keg used in the beverage dispensing system, thereby reducing the risk of bacterial growth or clogging in all these parts of the beverage dispensing system. In a possible implementation form of the second aspect the beverage dispensing system comprises a compressor for pressurizing the exchangeable keg, preferably an air compressor.

In a possible implementation form of the second aspect the beverage dispensing system comprises a body that is provided with a receptacle for receiving at least part of the exchangeable keg and a lid arranged to cover at least part of the exchangeable keg when the keg is received in the receptacle.

In a possible implementation form of the second aspect the lid is secured to the body using a pressure-resistant connection, preferably a bayonet mount.

In a possible implementation form of the second aspect the body that is provided with a receptacle for receiving at least part of the exchangeable keg, together with the lid defines a sealable enclosure serving as a pressure chamber for pressurizing the keg inside the enclosure.

In a possible implementation form of the second aspect the beverage dispensing system comprises a fourth snap fit arrangement between the tapping head and the body of the lid to releasably retain the tapping head in the operating position.

In a possible implementation form of the second aspect the at least one keg comprises a beverage filled bag inside an outer shell, and wherein pressurized fluid from the compressor can be applied to the space between the outer shell and the bag for pressurizing the at least one keg.

In a possible implementation form of the second aspect the beverage dispensing system comprises a cooling device for cooling of the at least one keg and any beverage accommodated therein.

In a possible implementation form of the second aspect the beverage is beer, a carbonated malt based beverage, including non-alcoholic beer, or cider.

In a possible implementation form of the second aspect the one or more kegs are recyclable or disposable.

According to a third aspect, there is provided a beverage dispensing system according to any one of the possible implementation forms of the second aspect, the beverage dispensing system comprising a beverage font assembly according to any one of the possible implementation forms of the first aspect.

These and other aspects will be apparent from and the embodiment(s) described below.

### BRIEF DESCRIPTION OF THE DRAWINGS

In the following detailed portion of the present disclosure, the aspects, embodiments and implementations will be explained in more detail with reference to the example embodiments shown in the drawings, in which:

FIG. 1 shows a side view of a tapping head of a beverage font assembly with an insertable applicator in accordance with an embodiment;

FIGS. 2A and 2B show side views of a beverage font assembly in an operative position (P1) and a service position (P2) in accordance with an embodiment;

FIGS. 3A and 3B show side views of a beverage font assembly movable between an operative position (P1) and a service position (P2) accordance with in further alternative embodiments;

FIG. 4 shows a side view of an applicator for placing an exchangeable valve and a portion of an exchangeable dispensing line in a valve cavity in accordance with an embodiment;

FIG. 5 shows a side view of an applicator with an exchangeable valve and a portion of an exchangeable dispensing line in accordance with an embodiment;

FIG. 6 shows a side view of a tapping head of a beverage font assembly with an inserted applicator, exchangeable valve and exchangeable dispensing line in accordance with an embodiment;

FIGS. 7A and 7B illustrate steps of removing an applicator, exchangeable valve and exchangeable dispensing line from a tapping head of a beverage font assembly in accordance with an embodiment;

FIG. 8 shows a cross-section of a beverage font assembly with an inserted applicator, exchangeable valve and exchangeable dispensing line in accordance with an embodiment;

FIGS. 9A and 9B show side views of beverage dispensing systems comprising beverage font assemblies and exchangeable kegs in accordance with alternative embodiments;

FIG. 10 shows a close-up cross-section of a tapping head of a beverage font assembly with an inserted applicator in accordance with an embodiment; and

FIG. 11 shows a cross-section of a beverage dispensing system comprising a beverage font assembly and an exchangeable keg in accordance with an embodiment.

### DETAILED DESCRIPTION

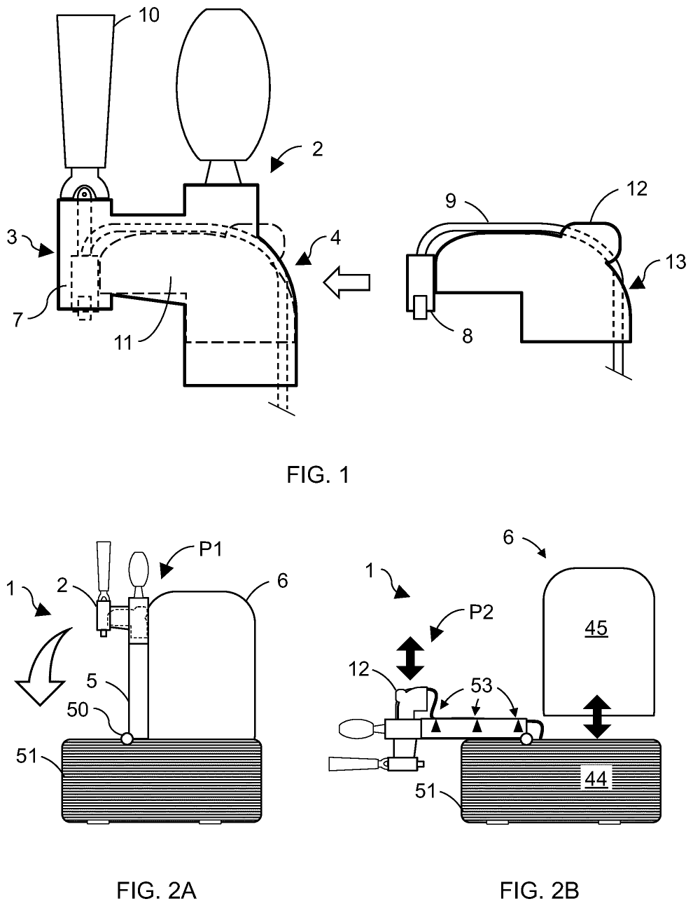

FIG. 1 shows a side view of a tapping head 2 of a beverage font assembly 1 for dispensing a beverage according to an embodiment of the present disclosure. The beverage may be for example beer, a carbonated malt based beverage, including non-alcoholic beer, or cider.

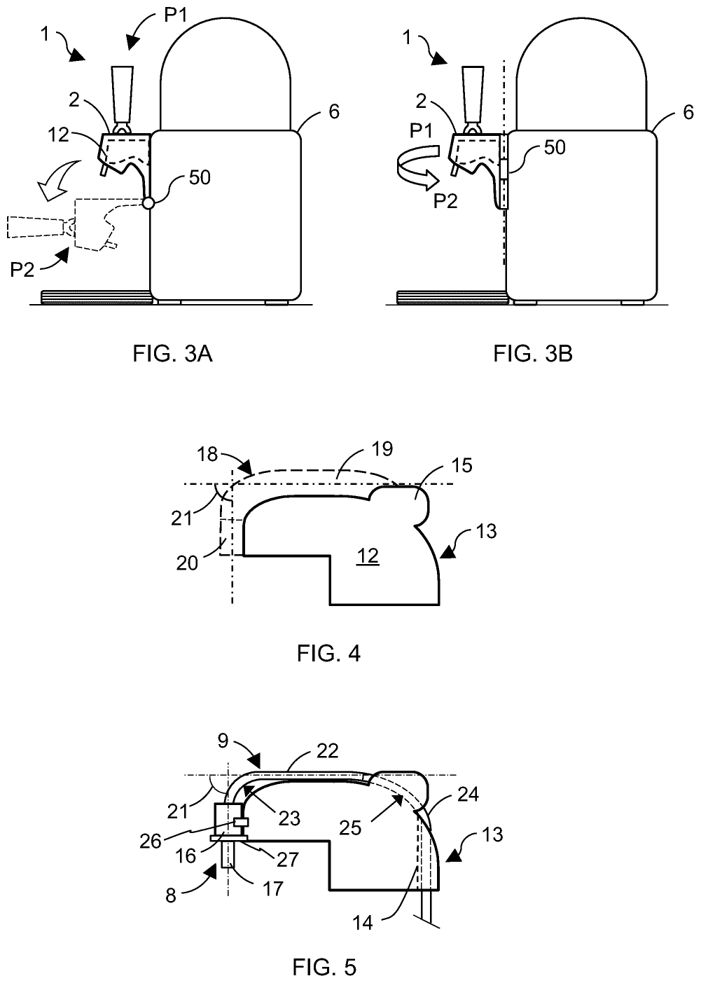

Exemplary beverage font assemblies 1 suitable for use with the tapping head 2 are shown in FIGS. 2A and 3A. Accordingly, the tapping head 2 may be supported by a beverage font 5 as shown in FIG. 2A, or may be supportable by a body 6 of a beverage dispensing system as shown in FIG. 3A, where instead of using a beverage font the tapping head 2 is directly attached to a housing of a beverage dispensing system that can hold a beverage container.

The tapping head 2 has a front side 3 facing away from the beverage font 5 or body 6, an opposing rear side 4, and a valve cavity 7 arranged therein, preferably in the vicinity of the outflow opening of the tapping head 2, and more preferably arranged at front side 3 of the tapping head 2, the valve cavity 7 being adapted to receive an exchangeable valve 8. The tapping head 2 is further provided with a tap handle 10 configured to be operatively connected to the exchangeable valve 8 for controlling of the opening and closing thereof when the exchangeable valve 8 is received in the valve cavity 7, and thus ultimately for controlling the flow of beverage from a dispensing line 9 through the tapping head 2. The tapping head 2 may further be provided with a tapping display arranged on top for displaying information about the beverage on tap at the respective tapping head.

The valve cavity 7 is arranged at a first lateral distance from the rear side 4, and the tap handle 10 is arranged at a second lateral distance from the rear side 4 of the tapping head 2. The first lateral distance and the second lateral distance may be the same as shown in FIG. 1, but in other embodiments they may be different, i.e. the tap handle 10 and valve cavity 7 being off-axis with respect to each other.

The tapping head 2 further comprises a first recess 11 extending from the above-described valve cavity 7 to the rear side 4 of the tapping head 2 and opening towards at least the rear side 4 of the tapping head 2.

An applicator 12 is further provided for placing the exchangeable valve 8 and at least a portion of an exchangeable dispensing line 9 in the valve cavity 7. The applicator 12 is sized and shaped to be slidably received in the first recess 11 and configured for having at least an exchangeable valve 8 releasably attached thereto, optionally along with a portion of an exchangeable dispensing line 9, as shown in the right. The placement of the exchangeable valve 8 is then executed by inserting the applicator 12 into the first recess 11 once the exchangeable valve 8 is attached to the applicator 12, as shown in the left, with the applicator, exchangeable valve 8, and exchangeable dispensing line 9 illustrated with dashed line. In other words, the applicator 12 is accessible and removable from a rear side 4 or a top side (not shown here) of the tapping head 2, for replacing at least one of the exchangeable valve 8 and the portion of an exchangeable dispensing line 9, from the valve cavity 7 and second recess 18.

FIGS. 2A and 2B show side views of a beverage font assembly 1 in accordance with an embodiment of the present disclosure, wherein the tapping head 2 is mounted on a beverage font 5. In these embodiments the tapping head 2 is arranged to be movable between an operative position P1 and a service position P2, preferably by tilting the beverage font assembly 1 towards the front side 3 around a hinge 50 arranged at the base of the beverage font 5. This tilting is preferably possible to a degree between 0-90 degrees around the hinge 50 from the vertical axis, more preferably to at least 45 degrees from the vertical axis. The rear side 4 of the tapping head 2 that is obscured in the operative position P1 shown in FIG. 2A thus becomes exposed in the service position P2 shown in FIG. 2B, for making it possible to insert or remove the applicator 12, as will be explained in more detail below. As shown in FIG. 2B, when the beverage font assembly 1 is tilted to 90 degrees it may rest at a base portion 51 of the beverage dispensing system arranged below the beverage font assembly 1. The contact surface between the beverage font assembly 1 and the base portion 51 may be a surface comprising a drip tray adapted to place beverage glasses on for receiving the beverage from the tapping head 2.

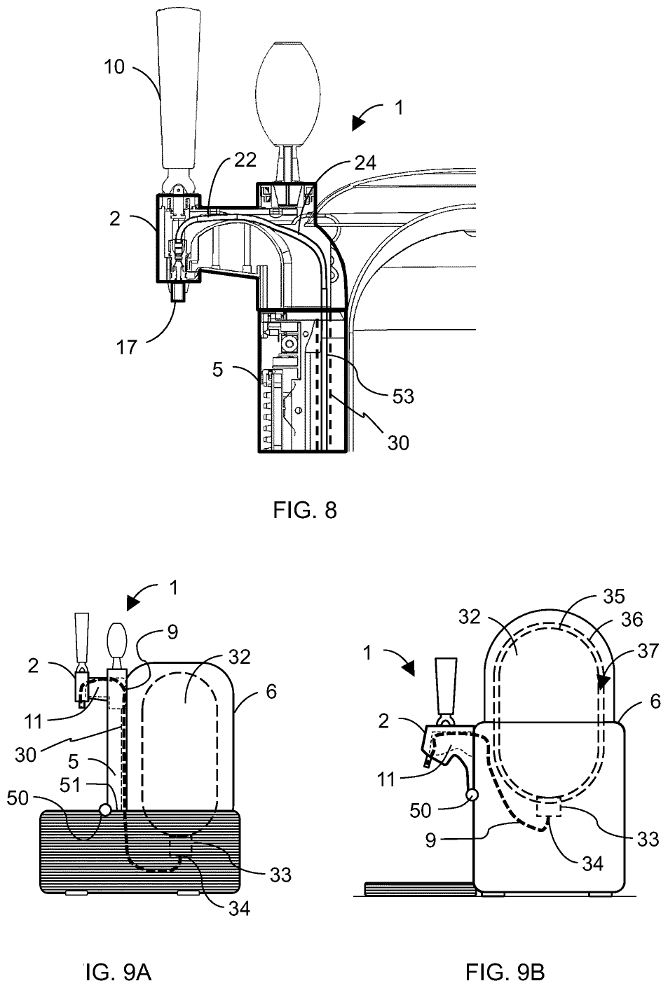

In this service position P2 a beverage font 5 of the beverage font assembly 1 (where applicable) can also reveal visual indicators 53 which guide the user at which particular locations to push the exchangeable dispensing line 9 into a third recess 30 arranged at a rear side of the beverage font 5 after replacing the keg 32, as explained below with respect to FIG. 8. These visual indicators 53 can be implemented according to a particular color coding that corresponds to a user manual, e.g. distinct green marks over a black surface. As further shown in FIG. 2B, when the beverage font assembly 1 is tilted forwards, an upper portion of the body 6 of the beverage dispensing system defined as the lid 45 may be separated at least partially from a lower portion of the body 6 defined as the receptacle 44, thereby further allowing a beverage container, such as an exchangeable keg 32, to be removed from the body 6 and replaced, as will be explained in more detail below with respect to FIG. 11.

FIGS. 3A and 3B show side views of a beverage font assembly 1 in accordance with further possible embodiments of the present disclosure, wherein the tapping head 2 is directly mounted on a body 6 of a beverage dispensing system.

In these embodiments the tapping head 2 is arranged to be movable between an operative position P1 and a service position P2, as explained above, to expose the rear side 4 of the tapping head 2 that is obscured in the operative position. In the embodiment shown in FIG. 3A the tapping head 2 is movable from an operative position P1 to a service position P2 (indicated with dashed lines) by tilting the tapping head 2 itself towards the front side 3 around a hinge 50 arranged at a connecting portion of the tapping head 2 and the body 6, preferably arranged at a lower portion thereof towards the base of the body 6. This tilting is preferably possible to a degree between 0-90 degrees, but at least 45 degrees around the hinge 50 compared to the operative position 1, and optionally even more than 90 degrees from the operative position 1 for allowing better access to the applicator through the rear side 4 of the tapping head 2.

In an alternative embodiment shown in FIG. 3B the tapping head 2 is movable from an operative position P1 to a service position P2 by rotating the tapping head 2 towards any side thereof around a vertical rotational axis defined at a connecting portion of the tapping head 2 and the body 6, using e.g. at least one hinge 50. This tilting is preferably possible to at least one side and to a degree between 0-90 degrees respectively, but at least 45 degrees around the rotational axis compared to the operative position 1, for allowing access to the applicator 12 through the rear side 4 of the tapping head 2.

FIG. 4 shows a side view of an applicator 12 for placing an exchangeable valve 8 and a portion of an exchangeable dispensing line 9 in the valve cavity 7 in accordance with an embodiment of the present disclosure. The applicator 12 defines a second recess 18 (indicated with dashed lines) arranged around the outer edge of the applicator's core, and shaped and sized to receive the exchangeable valve 8 and a first portion 22 of the exchangeable dispensing line 9 (see FIG. 5). The second recess 18 may be a space defined only by a distance around the applicator's core, or a guide channel defined by lateral walls extending from the applicator's core, sized to fit the exchangeable valve 8 and the dispensing line 9. As shown in FIG. 4, the second recess 18 may comprise a valve section 20 adapted to receive and/or positively retain the exchangeable valve 8, preferably arranged with an elongated shape to accommodate an elongated exchangeable valve 8; and/or dispensing line section 19 adapted to receive and/or retain the first 22 of the exchangeable dispensing line 9 therein.

In the embodiment shown in FIG. 4, at least an elongated part of the dispensing line section 19 defines a longitudinal axis of the dispensing line section 19 which is arranged at an angle 21, preferably an angle 21 between 45 and 110°, in relation to a longitudinal axis of the valve section 20. The valve section 20 preferably opens to a side of the applicator 12 that faces downward when the applicator 12 is inserted in the tapping head 2, at least when the tapping head 2 is in the operative position P1 as shown in FIG. 2A, 3A or 3B.

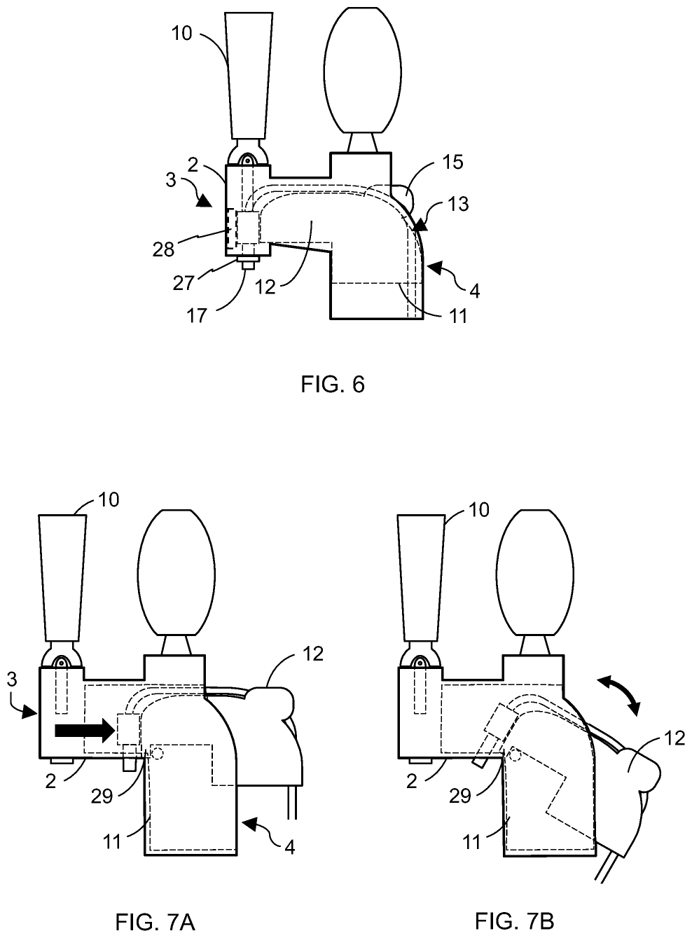

The applicator 12 comprises a rear applicator end 13 located at the rear side 4 of the tapping head 2 when the applicator 12 is fully inserted into the first recess 11. This rear applicator end 13 may at least partially protrude from the rear side 4 of the tapping head 2 when the applicator 12 is fully inserted into the first recess 11 to provide a grasping portion 15 for removing the applicator 12 from the first recess 11 (see FIG. 6).

The dispensing line section 19 may be arranged, as shown in FIG. 5, to receive a first portion 22 of the exchangeable dispensing line 9 comprising a first bend 23, preferably a 45 to 110° bend, more preferably a substantially 90° bend, roughly corresponding to the above-described angle 21 between the longitudinal axis of the valve section 20 and the longitudinal axis of the dispensing line section 19.

FIG. 5 shows a side view of an applicator 12 with an exchangeable valve 8 and a portion of an exchangeable dispensing line 9 in accordance with an embodiment of the present disclosure. In this embodiment, structures and features that are the same or similar to corresponding structures and features previously described or shown herein are denoted by the same reference numeral as previously used for simplicity. The exchangeable valve 8 may comprise a valve body 16 and a spout 17 connected to the valve body 16, the spout 17 preferably being an integral part of the valve body 16. The spout 17 may extend outside the tapping head 2 (see FIG. 6), such that the spout 17 is the last point of contact for the beverage to be dispensed from the beverage font assembly 1.

As shown in FIG. 5, the applicator 12 comprises a rear applicator end 13 which is located at the rear side 4 of the tapping head 2 when the applicator 12 is inserted into the first recess 11. In an embodiment as shown, a guide channel 14 is arranged at the rear applicator end 13 and adapted to receive and/or retain a second portion 24 of the exchangeable dispensing line 9 coming from a beverage container, such as an exchangeable keg 32. The second portion 24 of the exchangeable dispensing line 9 may comprise a second bend 25, preferably a 45 to 110° bend, more preferably a substantially 90° bend, wherein the guide channel 14 is configured to align an end of the second portion 24 with the rear side 4 of the tapping head 2 when the applicator 12 is fully inserted into the first recess 11.

As further shown in FIG. 5, the applicator 12 may further comprise a first snap fit arrangement 26 for releasably securing the exchangeable valve 8 to the applicator 12, and/or a second snap fit arrangement 27 for releasably securing a spout 17 to the applicator 12 or to the tapping head 2. Such snap fit arrangements are well known solutions for attaching flexible parts, usually plastic, and comprise interlocking components arranged on each respective part to be attached, to form a final product by pushing these interlocking components together. There are a number of variations in snap fit arrangements, including cantilever, torsional and annular. These arrangements, as integral attachment features, are a good alternative to assembly using nails or screws, and have the advantages of ability to detach and reattach the parts multiple times with no loose parts.

FIG. 6 shows a side view of a tapping head 2 of a beverage font assembly 1 with an inserted applicator 12, exchangeable valve 8 and exchangeable dispensing line 9 in accordance with an embodiment of the present disclosure. In this embodiment, structures and features that are the same or similar to corresponding structures and features previously described or shown herein are denoted by the same reference numeral as previously used for simplicity. As shown in FIG. 6, the tapping head 2 may comprise third snap fit arrangement 28 for releasably securing the applicator 12 in the first recess 11. This third snap fit arrangement 28 may be located between any two contact surfaces of the applicator 12 and the tapping head 2, FIG. 6 merely shows one example of such an arrangement. In fit this embodiment, the second snap arrangement 27 is adapted for releasably securing the spout 17 to the tapping head 2, wherein the exchangeable valve 8 is adapted to be slid laterally into a sealing contact with the spout 17 from the side of the rear side 4, as the applicator 12 is inserted into the first recess 11, as further shown in

FIG. 7A. FIG. 6 also illustrates the rear applicator end 13 protruding from the rear side 4 of the tapping head 2 when the applicator 12 is fully inserted into the first recess 11 and thereby providing a grasping portion 15 for removing the applicator 12 from the first recess 11, as illustrated in FIGS. 7A and 7B.

FIGS. 7A and 7B illustrate steps of removing the applicator 12, exchangeable valve 8 and exchangeable dispensing line 9 from a tapping head 2 of a beverage font assembly 1 in accordance with an embodiment of the present disclosure. In this embodiment, structures and features that are the same or similar to corresponding structures and features previously described or shown herein are denoted by the same reference numeral as previously used for simplicity. As shown in these figures, the first recess 11 is shaped to allow both translational and rotational movement of the applicator 12 therein. To help and guide these translational and rotational movements the applicator 12 and/or first recess 11 may further comprise an end stop 29 adapted to limit translational and/or rotational movement of the applicator 12 in the first recess 11. In the illustrated embodiment the end stop 29 is arranged on the applicator 12 to correspond to a guide channel arranged in the first recess (not shown) and to limit lateral sliding movement of the applicator 12 to a degree and then allow clockwise rotation of the applicator 12 around the end stop 29 due to the shape of the first recess 11. This lateral and rotational movement exposes the exchangeable valve 8 and exchangeable dispensing line 9 to a sufficient amount that allows a user to detach and remove at least the exchangeable valve 8 from the tapping head 2, but preferably also the exchangeable dispensing line 9. A new or cleaned exchangeable valve 8 and exchangeable dispensing line 9 can subsequently be attached to the applicator 12 in its rotated position as shown in FIG. 7B, after which the applicator with the exchangeable valve 8 and exchangeable dispensing line 9 attached thereto can be rotated around the end stop 29 counter-clockwise to a horizontal position as shown in FIG. 7A.

Finally, the applicator can be slid towards the front side 3 of the tapping head 2 into the first recess 11, thereby sliding the exchangeable valve 8 with an attached spout 17 into its operative position at the lower side of the tapping head 2. As illustrated in FIG. 7A and 7B, the lower side of the tapping head 2 may comprise a guide portion for receiving the exchangeable valve 8 with the attached spout 17 and releasably securing to its operative position. This guide portion may comprise a snap fit arrangement as explained above.

FIG. 8 shows a cross-section of a beverage font assembly 1 with an inserted applicator 12, exchangeable valve 8 and exchangeable dispensing line 9 in accordance with an embodiment of the present disclosure. In this embodiment, structures and features that are the same or similar to corresponding structures and features previously described or shown herein are denoted by the same reference numeral as previously used for simplicity. In the embodiment shown in FIG. 8, the beverage font assembly 1 comprises a beverage font 5 arranged therein with a third recess 30 at a rear side of the beverage font 5 for receiving a third portion 53 of the exchangeable dispensing line 9 extending towards a beverage container. This third recess 30 preferably extends from the first recess 11 in the tapping head 2 to a base 51 of the beverage font 5 as shown in FIG. 9A, along the rear side of the beverage font 5. The third recess 30 may be a fully or partially exposed space defined by a distance measured from the edge of the beverage font 5, or may be arranged as a partially or fully enclosed channel running along the rear side of the beverage font 5 adapted to accommodate at least a portion of the exchangeable dispensing line 9, including the above-mentioned third portion 53.

FIGS. 9A and 9B show side views of beverage dispensing systems comprising beverage font assemblies 1 and exchangeable kegs 32 in accordance with alternative embodiments of the present disclosure. In these embodiments, structures and features that are the same or similar to corresponding structures and features previously described or shown herein are denoted by the same reference numeral as previously used for simplicity. The embodiment shown in FIG. 9A corresponds to the embodiment of FIG. 8, wherein the beverage font assembly 1 comprises a beverage font 5 for supporting the tapping head 2, and works in a similar fashion as described before and illustrated in FIGS. 2A and 2B for changing between an operative position P1 to a service position P2. As shown in FIG. 9A, the system comprises an exchangeable keg 32 for accommodating a beverage, the keg 32 comprising a closure 33 with a beverage outlet 34. The keg 32 may be recyclable or disposable after exchanging from an empty to a new keg 32. The dispensing line 9 extends from this beverage outlet 34, along the third recess at the rear side of the beverage font 5, to the first recess 11 arranged in the tapping head 2. As shown in FIG. 11 in more detail, the exchangeable dispensing line 9 has a dispensing end 38 for connecting to the exchangeable valve 8, and a keg connection end 39 for connecting to the beverage outlet 34. The embodiment shown in FIG. 9B corresponds to the embodiment and works in a similar fashion as described before and illustrated in FIGS. 3A and 3B, wherein the beverage font assembly 1 does not include a beverage font 5, instead the tapping head 2 is supported directly on a body adapted to accommodate an exchangeable keg 32. The exchangeable keg 32 can be the same for all the disclosed embodiments, comprising a closure 33 with a beverage outlet 34. As shown in FIG. 9B, the exchangeable dispensing line 9 extends from the beverage outlet 34, through the body 6, to the first recess 11 arranged in the tapping head 2. In this embodiment, the keg 32 comprises a beverage filled bag 35 inside an outer shell 36, wherein pressurized fluid from a compressor 43 may be applied to the space 37 between the outer shell 36 and the bag 35 for pressurizing the at least one keg 32 for initiating beverage flow through the exchangeable dispensing line 9 to the tapping head 2.

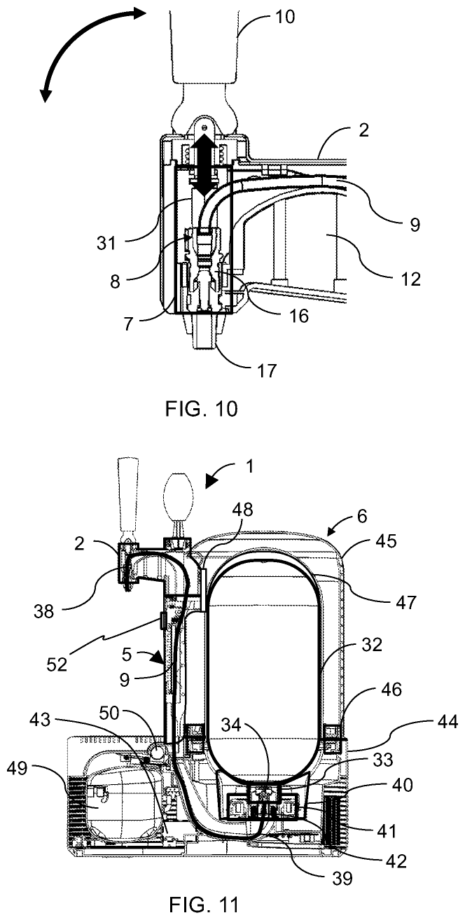

FIG. 10 shows a close-up cross-section of a tapping head 2 of a beverage font assembly 1 with an inserted applicator 12 in accordance with an embodiment of the present disclosure. In this embodiment, structures and features that are the same or similar to corresponding structures and features previously described or shown herein are denoted by the same reference numeral as previously used for simplicity. In the illustrated embodiment, the valve cavity 7 is arranged to house an actuator mechanism 31 configured to be operably connected to the tap handle 10 and to the exchangeable valve 8 when the exchangeable valve 8 is received in the valve cavity 7 by inserting the actuator 12 in the first recess 11 of the tapping head 2. The actuator mechanism 31 is adapted to translate movement of the tap handle 10 between a non- dispensing position and a dispensing position, initiated by a tilting movement of the tap handle 10 from vertical to an approximately horizontal position, into a movement, such as vertical sliding movement of the valve body 16, for changing the exchangeable valve 8 between closed and open configuration, by vertically moving a valve needle with respect to a valve seat within the valve body 16, thereby opening or closing beverage flow to and through the spout 17. The connection between tap handle 10 and the exchangeable valve 8 can be implemented by any known method in prior art tapping heads for beverages.

FIG. 11 shows a detailed cross-section of a beverage dispensing system comprising a beverage font assembly 1 and an exchangeable keg 32 in accordance with an embodiment of the present disclosure. The embodiment shown in FIG. 11 corresponds to the embodiment of FIG. 8, and works in a similar fashion as described before and illustrated in FIGS. 2A and 2B for changing between an operative position P1 to a service position P2. In this embodiment, structures and features that are the same or similar to corresponding structures and features previously described or shown herein are denoted by the same reference numeral as previously used for simplicity.

As shown in FIG. 11, the body 6 of the beverage dispensing system comprises a receptacle 44 and a lid 45. The receptacle 44 is designed and shaped for receiving at least a portion of the keg 32, preferably a smaller portion of the keg 32 comprising the closure 33 in an upside down position; and the lid 45 is arranged to cover at least a portion, preferably a larger portion of the keg 32 when the at least one keg 32 is received in the receptacle 44.

When these two parts are connected together, using a pressure- resistant connection 46, preferably a bayonet mount, a pressure-tight sealable enclosure 47 serving as pressure chamber is established. Herein, the terms “inner chamber” and “pressure chamber” are used interchangeably. The housing of the body 6 is made of pressure proof materials, such as metal or rigid plastic. A bayonet mount refers to a fastening mechanism well-known in the field consisting of a cylindrical male side with one or more radial pins, and a female receptor with matching L-shaped slot and with spring to keep the two parts locked together.

A keg closure cavity 40 is arranged at the bottom of the receptacle 44, designed to accommodate at least a portion of the keg 32. The keg closure cavity 40 comprises a coupler 41 with a through-hole 42 adapted for receiving at least one type of closure 33 of an exchangeable keg 32 and for allowing passage of the exchangeable dispensing line 9. The coupler 41 thus forms an access point for accessing the beverage outlet 34 of a beverage container, such as an exchangeable keg 32, and the beverage accommodated therein. The coupler 41 may be interchangeable in order to adapt the beverage dispensing system to an exchangeable dispensing line 9 or a fixed dispensing line, respectively.

The closure 33 of a suitable keg 32 is insertable into the keg closure cavity 40 and may be fixated to the coupler 41 in a sealed and pressure-tight fit. Preferably, the closure 33 is fixated to the coupler 41 e.g. by a screw fit, bayonet fit or the like. The closure 33 may itself provide sealing against its corresponding coupler 41, or alternatively, the coupler 41 or the keg closure cavity 40 may include a sealing element, which may seal against the closure 33.

The keg connection end 39 of the exchangeable dispensing line 9 sealingly fits into the through-hole 42 and serves as a sealing interphase and connects with the beverage outlet 34 of the keg 32.

The beverage containers used for the system may be blow moulded and of adapted in shape and volume to the volume of the pressure chamber realized by the receptacle 44 and the lid 45. This allows for mass production of both the beverage containers and the beverage dispensing systems. The pressure housing of the beverage dispensing system and the corresponding beverage containers may be provided in different sizes.

The exchangeable dispensing line 9 may be inserted and guided through the through-hole 42 of the coupler 41 before mounting the keg 32 in the receptacle 44, such that the keg connection end 39 of the dispensing line 9 abuts and sits sealingly in the coupler 41, positioned for connecting to the beverage outlet 34 upon mounting the keg 32 in the receptacle 44. The dispensing line 9 may also be provided with the keg 32, either as a separate item and attached to the closure 33 shortly before use, e.g. using a click connection mechanism, or in an alternative embodiment the dispensing line may also be permanently attached to the closure 33 of the keg. The dispensing line may then be guided through the through-hole 42 of the coupler 41 upon mounting the keg 32 in the receptacle 44.

The keg closure 33 may seal against the pressure chamber and may provide a flange onto which the keg 32 may rest and which may also be used for carrying the keg 32. The mouthpart of the keg 32, onto which the closure 33 is fixed in a fluid- tight, stable and permanent connection, is typically the same of all sizes of kegs and thus, the sole difference between the variants of the closures 33 may be whether an integrated dispensing line, a connectable dispensing line, or an openable seal is used. Thus, identical standardized closures 33 may be produced having a mouthpart, which may connect to standardized neck parts of kegs 32 that may have different sizes. The closures 33 may receive coupling parts having either a a breakable seal or an integrated dispensing line. The coupling parts may preferably be press fitted or clicked in place, however, other methods such as screw fits and welds are feasible.

The coupler 41 may be installed permanently in the keg closure cavity 40, such that the beverage dispensing system is permanently made to be used with the specific keg type. Alternatively, the user may be provided with different types of couplers 41 allowing the user to change coupler type on site in order to be able to modify the beverage dispensing system to be used with different keg types according to consumption of a particular beverage.

A pressure inlet may be adapted for receiving a pressure medium and transport the pressure medium to an interspace between the outer wall of the keg 32 and the inner wall of the sealable enclosure 47. The interspace is typically made as small as possible, e.g. a few millimeters of width, in order to allow a tight fit between a beverage container and a pressure chamber. The pressure inlet may form part of e.g. the receptacle 44, the lid 45 or the coupler 41, and may optionally include a one-way valve and/or overpressure valve. The pressure medium is typically air; however, any fluid would be feasible, such as CO2, N2, water etc.

The beverage dispensing system may comprise a compressor 43 and/or a gas cylinder selectively connectable to the pressure inlet for providing the pressure medium to the interspace. In order to make the system more modular, the pressure inlet and the beverage dispensing systems may be compatible with different pressurization units. A compressor 43 may be used when access to either mains power or battery power is available to power the compressor 43 allowing it to pressurize the pressure chamber by taking atmospheric air from the outside, pressurize it and inject the pressurized air into the interspace of the pressure chamber. A gas cylinder may be used where no mains power is available and/or batteries are considered an inconvenient choice. The gas cylinder is pre- loaded with a pressurized gas, e.g. air, nitrogen, carbon dioxide or the like.

The receptacle 44 and the lid 45 are separable for inserting and removing beverage containers, as shown e.g. in FIG. 2B. The separation of the receptacle 44 and the lid 45 may be dependent on tilting the beverage font 5 forward towards its front side 3 around a hinge 50 arranged at the base of the beverage font 5, as shown in FIG. 2A, to release locking means keeping the receptacle 44 and the lid 45 joined together in a pressure resistant connection. The tilting of the beverage font 5 may be further dependent on engaging pressure release means 52, such as a pressure release button 52 arranged on the front side 3 of the beverage font 5, which triggers pressure release in the pressure chamber, thereby allowing separation of the lid 45 from the receptacle 44 by equalizing pressure within the pressure-tight sealable enclosure 47 formed by the receptacle 44 and the lid 45 with the outside environment of the beverage dispensing system.

In some embodiments, the receptacle 44 and the lid 45 are only partially separable such that the lid 45 remains connected to the body 6, e.g. through a hinge. The sealable enclosure 47 may define a volume between 2 and 100 litres, preferably between 5 and 50 litres, more preferably between 10 and 25 litres. The above volumes constitute typical volumes of a pressure chamber. The beverage containers have a corresponding size, being slightly smaller for a tight fit inside the pressure chamber.

According to a further embodiment, the beverage dispensing system may comprise additional housing parts acting as a replacement of the lid 45, having an additional volume and being connectable to the receptacle 44 for establishing the sealable enclosure 47 serving as pressure chamber. In this way, the same base body 6 may be used together with different further housing parts of different size. In this way, the beverage dispensing system may be modified to a specific beverage container size, e.g. 5 liters, 10 liters or 20 liters. The additional housing parts may be exchangeable by the user, e.g. by providing a screw mount.

As shown in FIG. 11, according to an exemplary embodiment the beverage dispensing system may comprise a fourth snap fit arrangement 48 between the tapping head 2 and the body 6 or the lid 45 to releasably retain the tapping head 2 in the operative position P1.

The pressure chamber may be thermally insulated. The thermal insulation may be used in conjunction with a cooling device 49 for cooling of the at least one keg 32 and any beverage accommodated therein, or alternatively, the cooling device 49 may be dispensed with and instead a thermal insulation is used in conjunction with pre-chilled beverage containers in order to save weight in e.g. carry-on appliances.

The beverage dispensing system may further comprise a first electric power unit including a mains supply and a second power unit including a battery supply, and, optionally, a third power supply including a solar power supply. In order to further enhance the modularity of the system, it may be compatible with different power supplies. For fixed indoor installations, a mains power supply, e.g. 115V or 230V AC household supply, is preferred since it offers essentially unlimited power to the system for powering both cooling and pressurization units as well as other features such as lighting etc. Batteries may advantageously be used in mobile appliances. The batteries may e.g. be rechargeable by the use of a mains supply and a power converter. Solar power may be used for directly powering the beverage dispensing system, however, due to the limited output of solar cells when no direct sunlight is available it is mostly considered an auxiliary power unit to be used in conjunction with rechargeable batteries.

The various aspects and implementations have been described in conjunction with various embodiments herein. However, other variations to the disclosed embodiments can be understood and effected by those skilled in the art in practicing the claimed subject-matter, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems.

The reference signs used in the claims shall not be construed as limiting the scope. Unless otherwise indicated, the drawings are intended to be read (e.g., cross-hatching, arrangement of parts, proportion, degree, etc.) together with the specification, and are to be considered a portion of the entire written description of this disclosure. As used in the description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

1. A beverage font assembly for dispensing a beverage, the beverage font assembly comprising:
a tapping head defining a valve cavity for receiving an exchangeable valve for controlling the flow of beverage through the tapping head,
the tapping head comprising a first recess extending from the valve cavity to a side of the tapping head and opening towards at least the side of the tapping head,
wherein
the tapping head comprises an applicator for placing the exchangeable valve in the valve cavity by inserting the applicator into the first recess, the applicator being sized and shaped to be slidably received in the first recess, and the applicator being configured for having at least the exchangeable valve releasably attached thereto prior to insertion of the applicator into the first recess.

2. The beverage font assembly according to claim 1, wherein the tapping head is configured to be supported by a beverage font or supportable by a body of a beverage dispensing system,
wherein the tapping head comprises a front side facing away from the beverage font or body and an opposing rear side, and
wherein the first recess extends from the valve cavity to the rear side of the tapping head and opens towards at least the rear side of the tapping head.

3. The beverage font assembly according to claim 1, wherein the tapping head is provided with at least one tap handle configured to be operatively connected to the exchangeable valve for controlling of the opening and closing thereof when the exchangeable valve is received in the valve cavity.

4. The beverage font assembly according to claim 1,
wherein the valve cavity is further configured for receiving a portion of an exchangeable dispensing line,
wherein the exchangeable valve is configured for controlling the flow of beverage from the portion of an exchangeable dispensing line through the tapping head, and
wherein the applicator is further configured for placing the portion of the exchangeable dispensing line in the valve cavity.

5. The beverage font assembly according to claim 1, wherein the tapping head is movable between an operative position and a service position, the at least one side where the first recess extends and opens to being obscured in the operative position and exposed in the service position.

6. The beverage font assembly according to claim 1, wherein the applicator defines a second recess shaped and sized to receive and releasably engage the exchangeable valve,
wherein the second recess comprises a valve section adapted to receive and/or positively retain the exchangeable valve, and
wherein the second recess comprises a dispensing line section adapted to receive and/or retain a first portion of an exchangeable dispensing line.

7. The beverage font assembly according to claim 6, wherein at least an elongated part of the dispensing line section is arranged at an angle, in relation to a longitudinal axis of the valve section.

8. The beverage font assembly according to claim 6, wherein the dispensing line section is arranged to receive a first portion of the exchangeable dispensing line comprising a first bend.

9. The beverage font assembly according to claim 1, wherein the applicator is accessible and removable from a side of the tapping head, for replacing at least one of the exchangeable valve and a portion of an exchangeable dispensing line.

10. The beverage font assembly according to claim 1, wherein the applicator comprises a rear applicator end, and a guide channel arranged at the rear applicator end and being adapted to receive and/or retain a second portion of an exchangeable dispensing line.

11. The beverage font assembly according to claim 10, wherein the guide channel is configured to receive the second portion of the exchangeable dispensing line comprising a second bend, and to align an end of the second portion with the side of the tapping head when the applicator is fully inserted into the first recess.

12. The beverage font assembly according to claim 1, wherein the applicator comprises a rear applicator end located at a side of the tapping head when the applicator is fully inserted into the first recessm the rear applicator end at least partially protruding from the side of the tapping head when the applicator is fully inserted into the first recess to provide a grasping portion for removing the applicator from the first recess.

13. (canceled)

14. (canceled)

15. (canceled)

16. The beverage font assembly according to claim 1, wherein the first recess is shaped to allow both translational and rotational movement of the applicator therein.

17. The beverage font assembly according to claim 1, wherein the first applicator comprises an end stop adapted to limit translational and/or rotational movement of the applicator in the first recess.

18. The beverage font assembly according to claim 1, wherein the beverage font assembly comprises a beverage font, the beverage font being provided with a third recess for receiving a third portion of an exchangeable dispensing line, the third recess preferably extending from the first recess in the tapping head to a base of the beverage font.

19. The beverage font assembly according to claim 1, wherein the valve cavity is arranged to house an actuator mechanism, the actuator mechanism configured to be operably connected to a tap handle and to the exchangeable valve when the exchangeable valve is received in the valve cavity, wherein the actuator mechanism is configured to translate movement of the tap handle between a non-dispensing position and a dispensing position into a movement for changing the exchangeable valve between closed and open configuration.

20. A beverage dispensing system configured for receiving an exchangeable keg comprising a closure with a beverage outlet, an exchangeable dispensing line having a dispensing end and a keg connection end for connecting to the beverage outlet, and an exchangeable valve being connected to the dispensing end;
wherein the system comprises:
a beverage font assembly for dispensing a beverage from the exchangeable keg, the beverage font assembly comprising a tapping head configured for receiving the exchangeable valve;
a body defining a receptacle for receiving at least part of the exchangeable keg; and
a lid arranged to cover at least part of the exchangeable keg when the exchangeable keg is received in the receptacle; and
the receptacle comprising a keg closure cavity designed to accommodate the closure of the exchangeable keg,
wherein the keg closure cavity is provided with a coupler with a through-hole for allowing passage of the exchangeable dispensing line, and wherein the through-hole is configured to receive the keg connection end of the exchangeable dispensing line in a sealing manner and align the keg connection end with the beverage outlet of the exchangeable keg.

21. (canceled)

22. The beverage dispensing system according to claim 20,
wherein the lid is secured to the body using a pressure-resistant connection, and
wherein the body together with the lid defines a sealable enclosure serving as a pressure chamber for pressurizing the exchangeable keg inside the enclosure.

23. The beverage dispensing system according to claim 20, wherein the exchangeable keg comprises a beverage filled bag inside an outer shell , the beverage filled bag and outer shell defining a space in between where pressurized fluid can be applied for pressurizing the exchangeable keg.

24. (canceled)

25. The beverage dispensing system according to claim 20, wherein the beverage font assembly is a beverage font assembly.
